(19) United States
(12) Patent Application Publication
(10) Pub. No.: US 2013/0064355 A1
(43) Pub. Date: Mar. 14, 2013

(54) VARIABLE RADIUS TAPER X-RAY WINDOW SUPPORT STRUCTURE

(71) Applicant: Brigham Young University, Provo, UT (US)

(72) Inventor: Robert C. Davis, Provo, UT (US)

(73) Assignee: Brigham Young University, Provo, UT (US)

(21) Appl. No.: 13/670,710

(22) Filed: Nov. 7, 2012

Related U.S. Application Data
(63) Continuation-in-part of application No. 13/667,273, filed on Nov. 2, 2012.
Application No. 13/667,273 is a continuation-in-part of application No. 13/453,066, filed on Apr. 23, 2012.
(60) Provisional application No. 61/689,458, filed on Jun. 6, 2012.
(60) Provisional application No. 61/486,547, filed on May 16, 2011.
(60) Provisional application No. 61/495,616, filed on Jun. 10, 2011.
(60) Provisional application No. 61/511,793, filed on Jul. 26, 2011.

(51) Int. Cl. H05G 1/02

(52) U.S. Cl. 378/204

(57) ABSTRACT

A support structure for an x-ray window comprising a support frame defining a perimeter and an aperture, a plurality of ribs extending across the aperture of the support frame and carried by the support frame, and openings between the plurality of ribs. A rib taper region can extend from a central portion of the ribs to the support frame. The taper region can include a non-circular, arcuate pair of fillets on opposing sides of the ribs and an increasing of rib width from the central portion to the support frame.

### CLAIM OF PRIORITY

Priority is claimed to U.S. Provisional Patent Application Ser. No. 61/689,458, filed on Jun. 5, 2012; which is hereby incorporated herein by reference in its entirety.

This is a continuation-in-part of U.S. patent application Ser. No. 13/667,273, filed on Nov. 2, 2012, which is a continuation-in-part of U.S. patent application Ser. No. 13/453,066, filed on Apr. 23, 2012, which claims priority to U.S. Provisional Patent Application Nos. 61/486,547 filed on May 16, 2011, 61/495,616 filed on Jun. 10, 2011, and 61/511,793 filed on Jul. 26, 2011; all of which are hereby incorporated herein by reference in their entirety.

### FIELD OF THE INVENTION

The present application is related generally to x-ray window support structures.

### BACKGROUND

It is important for support members in support structures, such as x-ray window support structures, to be strong but also small in size. X-ray windows can include a thin film supported by the support structure, typically comprised of ribs supported by a frame. The support structure can be used to minimize sagging or breaking of the thin film. The support structure can interfere with the passage of x-rays and thus it can be desirable for ribs to be as thin or narrow as possible while still maintaining sufficient strength to support the thin film. The support structure and film are normally expected to be strong enough to withstand a differential pressure of around 1 atmosphere without sagging or breaking.

Such support structures can comprise a support frame defining a perimeter and an aperture, a plurality of ribs extending across the aperture of the support frame and carried by the support frame, and openings between the ribs. Stresses can occur at the junction of the ribs and the support frame. It can be important to reduce such stresses in order to avoid failure at this junction.

### SUMMARY

It has been recognized that it would be advantageous to have a strong x-ray window support structure, and advantageous to minimize stresses at a junction of the ribs to the support frame. The present invention is directed to an x-ray window support structure that satisfies these needs. The support structure comprises a support frame defining a perimeter and an aperture, a plurality of ribs extending across the aperture of the support frame and carried by the support frame, and openings between the plurality of ribs. A rib taper region can extend from a central portion of the ribs to the support frame. The taper region can include a non-circular, arcuate pair of fillets on opposing sides of the ribs and an increasing of rib width from the central portion to the support frame.

### BRIEF DESCRIPTION OF THE DRAWINGS

FIG. 1 is a schematic top view of an x-ray window support structure, in accordance with an embodiment of the present invention;

FIG. 2 is a schematic cross-sectional side view of an x-ray window, in accordance with an embodiment of the present invention;

FIG. 3 is a schematic top view of a portion of an x-ray window support structure, in accordance with an embodiment of the present invention;

FIG. 4 is a schematic top view of a portion of an x-ray window support structure, in accordance with an embodiment of the present invention;

FIG. 5 is a schematic top view of a portion of an x-ray window support structure, in accordance with an embodiment of the present invention;

FIG. 6 is a schematic top view of a portion of an x-ray window support structure, in accordance with an embodiment of the present invention; and

FIG. 7 is a schematic top view of a portion of an x-ray window support structure, in accordance with an embodiment of the present invention.

### DEFINITIONS

As used herein, the term “carbon fiber” or “carbon fibers” means solid, substantially cylindrically shaped structures having a mass fraction of at least 85% carbon, a length of at least 5 micrometers and a diameter of at least 1 micrometer.
As used herein, the term “directionally aligned,” in referring to alignment of carbon fibers with ribs, means that the carbon fibers are substantially aligned with a longitudinal axis of the ribs and does not require the carbon fibers to be exactly aligned with a longitudinal axis of the ribs.
As used herein, the term “rib” means a support member and can extend, linearly or with bends or curves, by itself or coupled with other ribs, across an aperture of a support frame.

### DETAILED DESCRIPTION

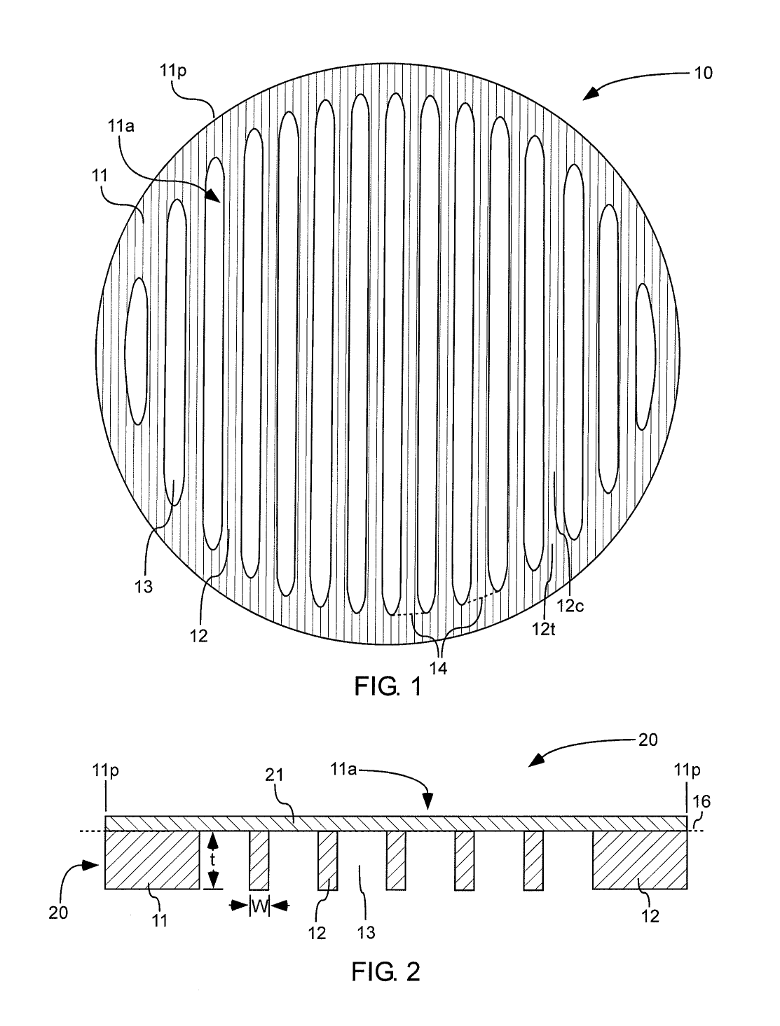

As illustrated in FIG. 1, a support structure 10 for an x-ray window is shown comprising a support frame 11 defining a perimeter 11p and an aperture 11a, a plurality of ribs 12 extending across the aperture 11a of the support frame 11 and carried by the support frame 11, and openings 13 between the plurality of ribs 12. The ribs 12 can be attached or joined to the frame 11 at a junction 14. Typically, the ribs 12 and frame 11 are formed integrally from a single wafer or sheet of material, but they can be formed separately and attached together, such as with an adhesive.

Shown in FIG. 2 is an x-ray window 20 having tops of the ribs 12 terminating substantially in a common plane 16. A thin film 21 can be disposed over and can be attached to the ribs 12 and the support frame 11.

When the thickness t of the ribs 12 is sufficiently thin, stress on the rib material can become very large near the junction 14 of the ribs 12 with the support frame 11. A rib taper region 12t (shown in FIG. 1) may be used to reduce stress at this junction 14.

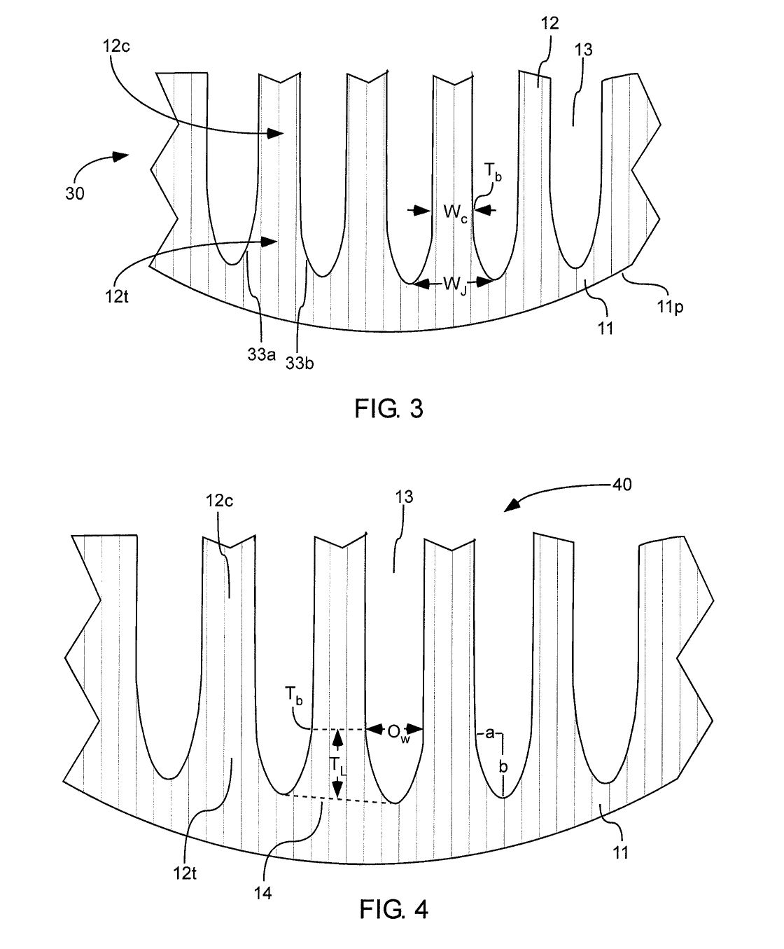

Shown in FIG. 3 is a section of a support structure 30. A rib taper region 12t can extend from a central portion 12c of the ribs 12 to the support frame 11. The taper region 12t can include a non-circular, arcuate pair of fillets 33a-b on opposing sides of the ribs 12. Non-circular, arcuate fillets 33 can allow for reduced stress, while also allowing ribs 12 to be spaced closer together. The taper region 12t can include an increasing of rib width W from the central portion 12c to the support frame 11 (W_{J}>W_{c}). Rib width W can continuously and smoothly increase, with no sharp angles or inflection points, from the central portion 12c to the support frame 11.

The support structures described herein may be further defined or quantified by the shape of the ribs, such as having a long length relative to an increase in rib width in the taper region 12t. The support structures described herein may also be defined or quantified by the shape of the openings 13 in the taper region 12t, such as a relationship of rib length in the taper region 12t to an opening width, a relationship of radius of curvature at a taper beginning to a radius of curvature at the support frame, or elliptical shaped openings. These definitions can be used to quantify the non-circular, arcuate shape of the fillets 33a-b of the taper region 12t.

As shown on support structures 30 and 40 in FIGS. 3-4, a location where the central portion 12c of the ribs 12 meets the taper region 12t defines a taper beginning T_{b}; a rib width at the taper beginning T_{b} defines a central rib width W_{c}; a rib width at a junction of the rib 12 with the support frame 11 defines a junction rib width W_{J}; and a straight line distance, parallel with a center of the rib 12, from the taper beginning T_{b} to the support frame 11 defines a taper length T_{L}. In one aspect, the central rib width W_{c}, the junction rib width W_{J}, and the taper length T_{L} can satisfy the equation:

$$1 < \frac{{T}_{L}}{{W}_{J} - {W}_{c}} < 3.$$

In another aspect, the central rib width W_{c}, the junction rib width W_{J}, and the taper length T_{L} can satisfy the equation:

$$1.4 < \frac{{T}_{L}}{{W}_{J} - {W}_{ c}} < 2.2 .$$

These equations can quantify a long length of the ribs 12 relative to an increase in rib width in the taper region 12t.

As shown on support structure 40 of FIG. 4, an opening 13 width at the taper beginning T_{b} defines a taper opening width O_{w}. The taper length T_{L} divided by the taper opening width O_{w} can be between 1 and 3

$$( 1 < \frac{{T}_{L}}{{O}_{w}} < 3 )$$

in one aspect, or between 1.4 and 2.2

$$( 1.4 < \frac{{T}_{L}}{{O}_{w}} < 2.2 )$$

in another aspect. These equations can quantify a long length of the ribs 12 in the taper region 12t relative to an opening width O_{w} at the taper beginning T_{b}.

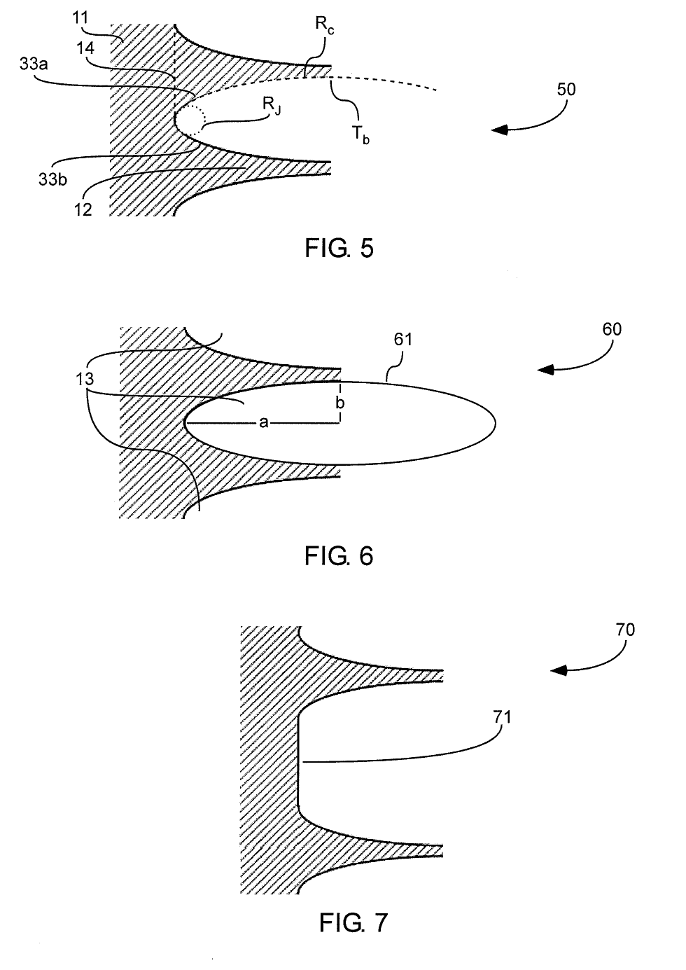

As shown on support structure 50 of FIG. 5, a radius of curvature of the fillets 33 at the taper beginning T_{b} defines a central radius R_{c} and a radius of curvature of the fillets at a junction of the ribs 12 with the support frame 11 defines a junction radius R_{J}. The central radius R_{c} divided by the junction radius R_{J} can be between 10 and 100

$$( 10 < \frac{{R}_{c}}{{R}_{J}} < 100 )$$

in one aspect. The central radius R_{c} divided by the junction radius R_{J} can be between 20 and 50

$$( 20 < \frac{{R}_{c}}{{R}_{J}} < 50 )$$

in another aspect. These equations can quantify a large radius of curvature at the taper beginning T_{b} relative to a substantially smaller radius of curvature at a junction of the ribs 12 with the support frame 11, thus quantifying the non-circular, arcuate shape of the ribs 12.

The larger radius of curvature closer to the central portion 12c of the ribs 12 can result in reduced stress in the ribs, and thus greater rib strength and reduced risk of rib failure. The gradually and continually decreasing radius of curvature towards the junction 14 can allow ribs 12 to be packed closer together. Thus, if a larger spacing between ribs 12 is allowed, such as if a relatively strong film is used, then the central radius R_{c} divided by the junction radius R_{J} can be relatively smaller. If a smaller spacing between ribs 12 is allowed, such as if a thinner or relatively weaker film is used, then the central radius R_{c} divided by the junction radius R_{J} may need to be larger.

As shown on support structure 60 of FIG. 6, openings 13 can have a half-elliptical shape 61 between ribs in the taper region 12t. Eccentricity e of the half-elliptical shape can be between 0.90 and 0.99 (0.90<e<0.99) in one aspect, between 0.80 and 0.99 (0.80<e<0.99) in another aspect, between 0.93 and 0.98 (0.93<e<0.98) in another aspect, or between 0.75 and 0.90 (0.75<e<0.90) in another aspect. Eccentricity e is defined as:

$$= \sqrt{1 - \frac{{b}^{2}}{{a}^{2}}} .$$

These equations can quantify the shape of openings 13 in the taper region 12t.

In previous figures, ribs 12 were shown packed closely together, such that where the rib taper for one rib 12 ended at the support structure 11, a rib taper for another rib 12 began. As shown on support structure 70 of FIG. 7, ribs 12 can be spaced farther apart, such that there is a region of an inner perimeter 71 of the support structure in which there are no ribs, and no beginning of taper of ribs.

The central portion 12c of the ribs 12 can have a substantially constant width W, and ribs can be substantially parallel with each other, as is shown on support structure 10 in FIG. 1. A variable rib width in the central portion 12c, or non-parallel ribs, such as hexagonal or intersecting ribs, are also within the scope of this invention.

The ribs 12 and/or the support frame 11 can comprise low atomic number elements such as aluminum, beryllium, boron, carbon, fluorine, hydrogen, nitrogen, oxygen, and/or silicon. Use of such low atomic number elements can result in minimized x-ray spectrum contamination. The ribs 12 and/or the support frame 11 can comprise boron carbide, boron hydride, boron nitride, carbon fiber composite, carbon nanotube composite, kevlar, mylar, polyimide, polymer, silicon nitride, diamond, diamond-like carbon, graphitic carbon, pyrolytic graphite, and/or amorphous carbon. The openings 13, ribs 12, and support frame 11 can be formed by laser ablation. Manufacturing of the support structure from a carbon composite wafer is described in U.S. patent application Ser. No. 13/667,273, filed on Nov. 2, 2012, and in U.S. patent application Ser. No. 13/453,066, filed on Apr. 23, 2012, which are hereby incorporated herein by reference. If a carbon composite support structure is used, carbon fibers in the carbon composite can be directionally aligned with the ribs 12.

The film 21, described previously in the description of FIG. 2, can be configured to pass radiation therethrough. For example, the film 13 can be made of a material that has a low atomic number and can be thin, such as for example about 5 to 500 micrometers (μm). The film 13 can have sufficient strength to allow differential pressure of at least one atmosphere without breaking. The film 13 can be hermetic or air-tight. The film 13 can combine with one of the support structures described herein and a shell to form a hermetic enclosure.

What is claimed is:

1. A support structure for an x-ray window, the support structure comprising:
a) a support frame defining a perimeter and an aperture;
b) a plurality of ribs extending across the aperture of the support frame and carried by the support frame;
c) the support frame and the ribs comprising a carbon composite material including carbon fibers embedded in a matrix;
d) openings between the plurality of ribs;
e) a rib taper region extending from a central portion of the ribs to the support frame;
f) the taper region including a non-circular, arcuate pair of fillets on opposing sides of the ribs; and
g) the taper region including an increasing of rib width from the central portion to the support frame.

2. The support structure of claim 1, wherein:
a) a location where the central portion of the ribs meets the taper region defines a taper beginning;
b) a radius of curvature of the fillets at the taper beginning defines a central radius;
c) a radius of curvature of the fillets at a junction of the ribs with the support frame defines a junction radius; and
d) the central radius divided by the junction radius is between 10 and 100.

3. The support structure of claim 1, wherein openings at the taper region have a half-elliptical shape.

4. The support structure of claim 3, wherein the half-elliptical shape has an eccentricity of between 0.90 and 0.99.

5. The support structure of claim 3, wherein the half-elliptical shape has an eccentricity of between 0.80 and 0.99.

6. The support structure of claim 1, wherein:
a) a location where the central portion of the ribs meets the taper region defines a taper beginning;
b) a straight line distance, parallel with a center of the rib, from the taper beginning to the support frame defines a taper length;
c) an opening width at the taper beginning defines a taper opening width; and
d) the taper length divided by the taper opening width is between 1 and 3.

7. The support structure of claim 6, wherein the taper length divided by the taper opening width is between 1.4 and 2.2.

8. The support structure of claim 1, wherein:
a) a location where the central portion of the ribs meets the taper region defines a taper beginning;
b) a rib width at the taper beginning defines a central rib width;
c) a rib width at a junction of the rib with the support frame defines a junction rib width;
d) a straight line distance, parallel with a center of the rib, from the taper beginning to the support frame defines a taper length; and
e) the central rib width, the junction rib width, and the taper length satisfy the equation:
$$1 < \frac{taper length}{junction rib width - central rib width} < 3.$$

9. The support structure of claim 8, wherein the central rib width, the junction rib width, and the taper length satisfy the equation:
$$1.4 < \frac{taper length}{junction rib width - central rib width} < 2.2 .$$

10. The support structure of claim 1, wherein tops of the ribs terminate substantially in a common plane, and further comprising a film disposed over, carried by, and spanning the plurality of ribs and disposed over and spanning the openings, and configured to pass radiation therethrough.

11. The support structure of claim 1, wherein the openings, ribs, and support frame were formed by laser ablation of a carbon composite wafer, and carbon fibers in the carbon composite are substantially aligned with the ribs.

12. The support structure of claim 1, wherein the central portion of the ribs have a substantially constant width.

13. A support structure for an x-ray window, the support structure comprising:
a) a support frame defining a perimeter and an aperture;
b) a plurality of ribs extending across the aperture of the support frame and carried by the support frame;
c) openings between the plurality of ribs;
d) a rib taper region extending from a central portion of the ribs to the support frame;
e) the taper region including a non-circular, arcuate pair of fillets on opposing sides of the ribs;
f) the fillets include a larger radius of curvature closer to the central portion of the ribs and a smaller radius of curvature towards the support frame; and
g) the taper region including an increasing of rib width from the central portion to the support frame.

14. The support structure of claim 13, wherein the ribs comprise carbon, carbon fiber composite, silicon, boron carbide, or combinations thereof.

15. The support structure of claim 13, wherein:
a) the support frame and the ribs comprise a carbon composite material including carbon fibers embedded in a matrix; and
b) the openings, ribs, and support frame were integrally formed by laser ablation of a carbon composite wafer.

16. The support structure of claim 13, wherein:
a) a location where the central portion of the ribs meets the taper region defines a taper beginning;
b) a radius of curvature of the fillets at the taper beginning defines a central radius;
c) a radius of curvature of the fillets at a junction of the ribs with the support frame defines a junction radius; and
d) the central radius divided by the junction radius is between 10 and 100.

17. The support structure of claim 13, wherein openings at the taper region have a half-elliptical shape having an eccentricity of between 0.80 and 0.99.

18. The support structure of claim 13, wherein:
a) a location where the central portion of the ribs meets the taper region defines a taper beginning;
b) a rib width at the taper beginning defines a central rib width;
c) a rib width at a junction of the rib with the support frame defines a junction rib width;
d) a straight line distance, parallel with a center of the rib, from the taper beginning to the support frame defines a taper length; and
e) the central rib width, the junction rib width, and the taper length satisfy the equation:
$$1 < \frac{taper length}{junction rib width - central rib width} < 3.$$

19. A support structure for an x-ray window, the support structure comprising:
a) a support frame defining a perimeter and an aperture;
b) a plurality of ribs extending across the aperture of the support frame and carried by the support frame;
c) tops of the ribs terminate in a common plane;
d) openings between the plurality of ribs;
e) a rib taper region extending from a central portion of the ribs to the support frame;
f) the taper region including a non-circular, arcuate pair of fillets on opposing sides of the ribs;
g) the taper region including an increasing of rib width from the central portion to the support frame;
h) openings at the taper region have a half-elliptical shape having an eccentricity of between 0.80 and 0.99; and
i) the ribs comprise carbon, carbon fiber composite, silicon, boron carbide, or combinations thereof.

20. The support structure of claim 19, wherein the openings and ribs were formed by laser ablation.
